(19) United States
(12) Patent Application Publication
(10) Pub. No.: US 2024/0220119 A1
(43) Pub. Date: Jul. 4, 2024

(54) METHODS AND SYSTEMS FOR DYNAMIC SUBMISSION DATA STRUCTURES

(71) Applicant: SK Hynix NAND Product Solutions Corp. (dba Solidigm), San Jose, CA (US)

(72) Inventor: Mieszko Dziadowiec, Gda?sk (PO)

(21) Appl. No.: 18/091,063

(22) Filed: Dec. 29, 2022

(51) Int. Cl. G06F 3/06

(52) U.S. Cl. CPC G06F 3/0613; G06F 3/064; G06F 3/0653; G06F 3/0659; G06F 3/0679

(57) ABSTRACT

A system and related method for a storage device driver, including storage circuitry and processing circuitry, which while executing a storage device driver, is to receive a first request of a request block size. The processing circuitry causes the first request to be stored in a first data structure from the plurality of data structures. The processing circuitry is then to determine a second data structure from the plurality of data structures based on the request block size of a second request. The processing circuitry is to cause the second request to be stored in the second data structure from the plurality of data structures.

### TECHNICAL FIELD

The present disclosure is related to systems and methods for dynamically storing instructions between data structures of a storage device driver, and more particularly, the present disclosure is related to improving instruction processing fairness and processor efficiency of processing units with higher data structure depth.

### SUMMARY

In accordance with the present disclosure, systems and methods are provided for dynamic submission data structures that are configured on a storage device, such as a solid-state drive (SSD) device, with large volumes of incoming requests while executing a storage device driver. For example, an SSD device that has storage circuitry, processing circuitry, and a memory (e.g., non-volatile memory), where data structures have high data structure depths. The data structure depth of a data structure is the number of requests currently stored in the data structure. The dynamic submission data structures may be implemented at least in part on the storage circuitry using software, hardware, or a combination thereof. In some embodiments, a high volume of incoming requests may, over time, cause a disparity in the amount of stored memory within each data structure of the plurality of data structures. This may cause a drop in processing fairness among the stored requests, wherein a bottlenecked request in a first data structure may wait longer to be processed than a more recently stored request in a second data structure with less data structure depth. In some embodiments, the disparity in data structure depths may also lead to a drop in operational quality of the storage device processing efficiency.

In some embodiments, the dynamic submission data structures can be used to improve processing efficiency of requests when a large volume of requests are received for any suitable device having processing circuitry executing a device driver, coupled to memory. In some embodiments, the device may, for example, be any suitable storage device that may use a memory device driver.

In some embodiments, the storage device (e.g., a solid-state drive device) is provided executing a storage device driver, with a processing circuitry and storage circuitry that is communicatively coupled to each other. In some embodiments, the processing circuitry includes a processor, and the storage circuitry includes a plurality of data structures. In some embodiments, the processing circuitry (which may also be referred to as the storage device driver) receives a first request of a request block size. The processing circuitry is to cause the first request to be stored in a first data structure of the plurality of data structures. The processing circuitry is further to determine a second data structure from the plurality of data structures based on the request block size and cause a second request to be stored in the second data structure from the plurality of data structures.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a storage device with a storage device driver and memory, in accordance with some embodiments of the present disclosure;

FIG. 2 shows an illustrative diagram of a storage device driver with a plurality of data structures of storage circuitry and processing circuitry, in accordance with some embodiments of the present disclosure;

FIG. 3 shows illustrative diagrams of a storage device driver at three different times (time t₁, time t₂, and time t₃), which depicts the storage device driver storing a received first request data in a first data structure and dynamically storing a received second request data into a second data structure, in accordance with some embodiments of the present disclosure;

FIG. 4 shows a flowchart illustrating a process for dynamically storing a second request into a second data structure, based on the request block size of the second request, in accordance with some embodiments of the present disclosure;

FIG. 5 shows a flowchart illustrating a process for determining to store a request in a second data structure, based on a preset number of requests and a depth of the first data structure, in accordance with some embodiments of the present disclosure; and

FIG. 6 shows a flowchart illustrating a process for determining to store a request in a second data structure, based on a preset data structure memory and a stored memory of the first data structure, in accordance with some embodiments of the present disclosure.

### DETAILED DESCRIPTION

In accordance with the present disclosure, storage device systems and methods are provided for dynamic submission data structures of a storage device driver. In particular, the present disclosure provides systems and methods for high data structure depths in a storage device driver to improve the operational quality of the system (e.g., improve processing efficiency when data structures of the storage device driver have a high number of outstanding requests). In some embodiments, the storage device driver includes a plurality of data structures, wherein the plurality of data structures is one of a plurality of buffers, a plurality of queues, a plurality of stacks, and a plurality of heaps. Each data structure of the plurality of data structures is configured to store requests received by the storage device driver. In some embodiments, the plurality of data structures may be a part of a storage circuitry of the storage device driver.

A system (e.g., a storage device) may include processing circuitry and storage circuitry with a plurality of data structures, wherein both processing circuitry and storage circuitry is wrapped within the storage device driver. In some embodiments, the requests are to be driven on a network bus or interface. In some embodiments, processing circuitry of the system may comprise of a processing unit (e.g., a processor), which may operate on a received first request, wherein the processing circuitry receives the first request. When the first request is received by the processing circuitry, the first request may be stored in a first data structure, as the first request remains until it is processed. In some embodiments, there may be a second data structure which has significantly fewer outstanding requests to be processed, wherein the difference in data structure depths may lead to a bottleneck in processing requests in the first data structure. In some embodiments, request processing may be completed by a single processor, therefore a bottleneck may be caused in the first data structure and a reduced processing fairness among requests of data structures with large differentials in request depth. In some embodiments, request processing may be completed by multiple processors, such that, for example, each processor is assigned to a particular subset of data structures. In such an embodiment, data structures with large request depths may cause starving of other data structures and therefore causing some processors to idle, reducing the processing efficiency of the system. According to the present disclosure, dynamic request submission data structures for the storage device driver may enable an improved processing efficiency of the storage device with a high volume of received requests. In some embodiments of a previous example, wherein the first data structure has a large number of outstanding requests and a second data structure is available with less outstanding requests, the processing circuitry may determine to dynamically store a second into the second data structure, in order to achieve dynamic load balancing, by the storage device driver, of the requests among the plurality of data structures.

In some embodiments, a processor of the processing circuitry may be a highly parallelized processor capable of handling high bandwidths of requests quickly (e.g., by starting simultaneous processing of new requests before completion of previous requests).

In some embodiments the system and methods of the present disclosure may refer to an SSD storage system, which includes a storage device driver with a plurality of data structures for a network protocol interface, such as non-volatile memory express (NVMe) buffers.

An SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retains data without power and include a type of non-volatile storage technology. Quality of Service (QoS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

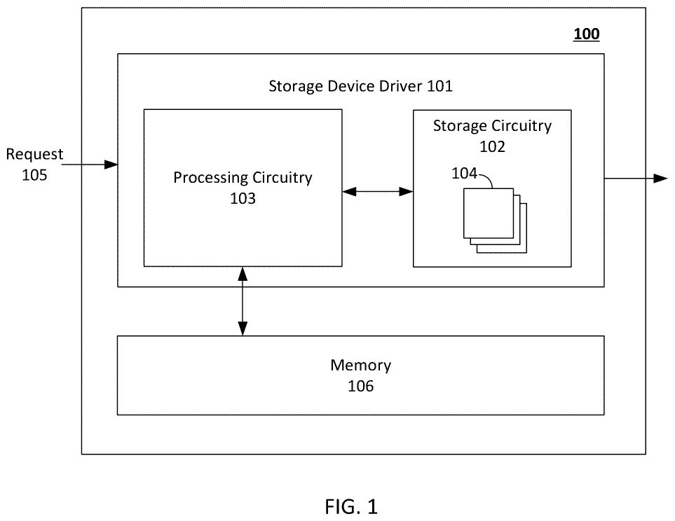

The subject matter of this disclosure may be better understood by reference to FIGS. 1-6.

FIG. 1 shows an illustrative diagram of a storage device 100 with a storage device driver 101 and memory 106, in accordance with some embodiments of the present disclosure. In some embodiments, storage device 100 may be a solid-state storage device (e.g., a solid-state drive device). In some embodiments, the storage device driver 101 includes processing circuitry 103 and storage circuitry 102, which stores a plurality of data structures 104. In some embodiments, each data structure is configured to dynamically store requests received by the storage device driver 101. In some embodiments, processing circuitry 103 may include a processor or any suitable processing unit. In some embodiments, memory 106 may be non-volatile memory. It will be understood that the embodiments of the present disclosure are not limited to SSDs. For example, in some embodiments, the storage device 100 may include a hard disk drive (HDD) device in addition to or in place of an SSD.

In some embodiments, storage device driver 101 receives at least one request 105 from a source. In some embodiments, the request source may be located externally of the storage device 100. In other embodiments, the at least one request may originate from within the storage device 100. In some embodiments, the storage device driver 101 receives requests (e.g., request 105) from both internal and external sources of the storage device 100. According to the present disclosure, there may be examples of storage device 100 in which there is a large number of requests (e.g., request 105) received by the storage device driver 101 such that each data structure of the plurality of data structures 104 have high data structure depths, which may lead to the additional latency as some data structures are bottlenecked as the requests are processed.

Additionally, storage device 100 includes storage circuitry 102 and memory 106. In some embodiments, memory 106 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), and a Magnetoresistive Random Access Memory (MRAM), any other suitable memory, or any combination thereof. In some embodiments, processing circuitry 103 is communicatively coupled to storage circuitry 102, in order to store and access requests in each data structure of the plurality of data structures 104. In addition, in some embodiments, the processing circuitry 103 is communicatively coupled to the memory 106. In some embodiments, a data bus interface is used to transport requests (e.g., request 105) or an address or data associated with the request. The data bus between the memory 106 and processing circuitry 103 provides a network bus for the reading or writing of data through memory 106. In some embodiments, the processor of processing circuitry 103 may include a hardware processor, a software processor (e.g., a processor emulated using a virtual machine), or any combination thereof. The processor, also referred to herein as processing circuitry 103, may include any suitable software, hardware, or both for controlling the storage device driver 101, storage circuitry 102, and the plurality of dynamic submission data structures. In some embodiments, the capabilities of the processor or processing circuitry 103 may be also be referred to as capabilities of the storage device driver 101. Memory 106 may include hardware elements for non-transitory storage of instructions, commands, or requests.

The storage device driver 101 is configured to receive a first request (e.g., request 105) and cause the first request to be stored in a first data structure of the plurality of data structures 104. In some embodiments, the first data structure may have a high data structure depth, which may cause an increase in latency, reducing the processing efficiency of the storage device 100. The data structure depth of a data structure is the number of requests currently stored in the data structure. In some embodiments, the storage device driver 101 may determine a second data structure of the plurality of data structures 104 based on the request block size. Once the storage device driver 101 determines a second data structure, the storage device driver 101 causes a second request to be stored in the second data structure. In some embodiments of the present disclosure, the storage device driver 101 receives the second request after the first request.

In some embodiments, each data structure of the plurality of data structures 104 is of the same type of data structure. For example, in some embodiments, the plurality of data structure 104 is one of a plurality of buffers, a plurality of queues, a plurality of stacks, a plurality of heaps or a plurality of any other suitable data structure.

Storage devices (for example, SSD devices) may include one or more packages of non-volatile memory dies, where each die includes storage cells. In some embodiments, the storage cells are organized into pages, and pages are organized into blocks. Each storage cell can store one or more bits of information. In some embodiments, the storage device 100 may further include a multi-core processor.

It will be understood that, while storage device 100 depicts an embodiment in which a storage device is configured to have dynamic submission data structure capabilities in accordance with the present disclosure, any other suitable device can have dynamic submission data structures in a similar manner.

For purposes of clarity and brevity, and not by way of limitation, the present disclosure is provided in the context of dynamic submission data structures for high data structure depth, that provides the features and functionalities disclosed herein. The dynamic submission data structures may be configured by any suitable software, hardware, or both for implementing such features and functionalities. Dynamic submission data structures may be at least partially implemented in, for example, storage device 100 (e.g., as part of storage device driver 101, or any other suitable device on which efficiency may improve at high data structure depths). For example, for a solid-state storage device (i.e., storage device 100), dynamic submission data structures may be implemented in storage device driver 101. In some embodiments, dynamic submission data structures can be at least partially implemented as part of an operating system for a system in which the storage device driver 101 is integrated.

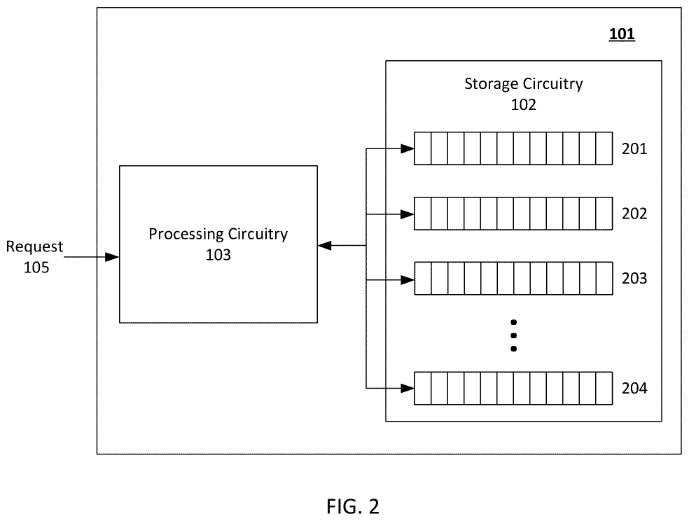

FIG. 2 shows an illustrative diagram of a storage device driver 101 with a plurality of data structures (e.g., 201, 202, 203, 204) in storage circuitry 102 and processing circuitry 103, in accordance with some embodiments of the present disclosure. Although four data structures are shown in FIG. 2, the number of data structures is not limited to four and any suitable number of data structures may be used. In some embodiments, the storage device driver is loaded on an operating system of the storage device (e.g., storage device 100). In some embodiments, the storage device driver 101 includes a plurality of data structures (e.g., 201, 202, 203, 204), wherein each data structure is configured to store data associated with received requests (e.g., request 105). The processing circuitry 103 may be commutatively coupled to storage circuitry 102, such that the processing circuitry can access the data stored in each data structure of the plurality of data structures (e.g., 201, 202, 203, 204).

In some embodiments, the storage device driver 101 receives requests (e.g., request 105) from multiple sources. In some embodiments, the source of request 105 is from another device, located externally of the storage device 100. In some embodiments, the source of request 105 may be located in the storage device 100, such as an application programming interface (API). In some embodiments, the storage device driver 101 is able to receive and process multiple requests (e.g., request 105) by using temporary memory such as the plurality of data structures (e.g., 201, 202, 203, 204) to store multiple requests before the requests are processed.

In some embodiments, each data structure of the plurality of data structures (e.g., 201, 202, 203, 204) may store request data or an address pointing to request data stored in memory (e.g., memory 106). In some embodiments, the processing circuitry 103 may access the data structure depth of each data structure of the plurality of data structures (e.g., 201, 202, 203, 204), in order to monitor whether the data structure depth of a data structure exceeds a preset number of requests determined by the storage device driver. In some embodiments, the processing circuitry 103 may access the stored memory of each data structure, to monitor whether the stored memory of any data structure of the plurality of data structures (e.g., 201, 202, 203, 204) exceeds a preset data structure memory. In some embodiments, the device storage driver 101 may use the preset number of requests or a preset data structure memory as a threshold to determine whether to dynamically move a request 105, which has been stored in a first data structure of the plurality of data structures, to a second data structure.

For example, the storage device driver 101 may store a first request in a first data structure 201 and the storage device driver 101 determines the data structure depth of a first data structure 201 exceeds the preset number of requests. The storage device driver 101 may determine a second data structure 202 in which to store a second request. In some embodiments, the storage device driver 101 determines the second data structure 202 wherein the data structure depth of the second data structure 202 does not exceed the preset number of requests and has more available memory capacity remaining than the second request block size. In general, the second request block size is the largest possible memory size of the received second request, and therefore the largest amount of data memory that can be accessed by a single request. In some embodiments, the second request may not be stored into a second data structure 202 if each data structure of the plurality of data structures (e.g., 201, 202, 203, 204) does have not enough available memory capacity remaining to store the second request or has a data structure depth that is greater than the data structure depth of the first data structure 201. However, once the storage device driver 101 determines a second data structure 202, the storage device driver causes the second request to be stored in the second data structure 202.

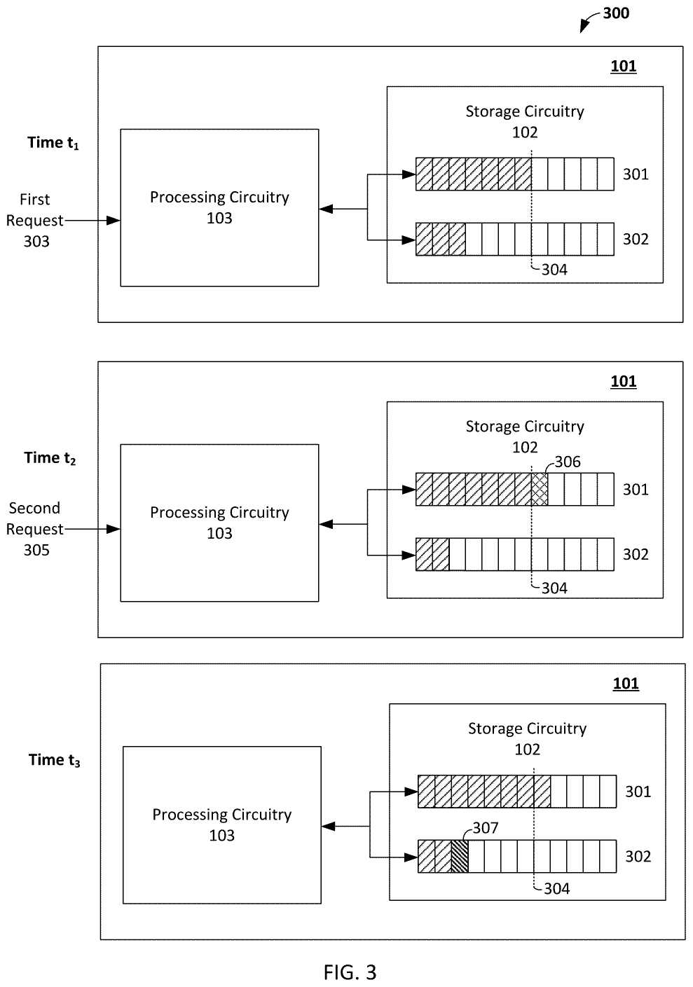

FIG. 3 shows illustrative diagrams 300 of a storage device driver 101 at three different times (time t₁, time t₂, and time t₃), which depicts the storage device driver 101 storing a received first request 303 in a first data structure 301 and dynamically storing a received second request 305 into a second data structure 302, in accordance with some embodiments of the present disclosure. Although the diagrams 300 illustrate a storage device driver 101 with two data structures (i.e., first data structure 301 and second data structure 302), the plurality of data structures of the storage circuitry 102 may include at least two data structures. In some embodiments, the storage device driver 101 includes a plurality of data structures (e.g., 301 and 302), wherein each data structure is configured to store request data (e.g., first request data 306 and second request data 307) associated with the received requests (e.g., first request 303 and second request 305). The processing circuitry 103 may be commutatively coupled to storage circuitry 102, such that the processing circuitry can access the data stored in each of the first data structure 301 and second data structure 302. In some embodiments, the memory capacity of the first data structure 301 is to be the same as the memory capacity of the second data structure 302.

At time t₁, the storage device driver 101 receives a first request 303. At the time, the first data structure 301 has a data structure depth of seven stored entries, and the second data structure 302 has a data structure depth of three stored entries. In some embodiments, the storage device driver 101 determines a preset number of requests 304 before receiving the first request 303. In other embodiments, the storage device driver 101 may determine the preset number of requests 304 after receipt of the first request 303. The storage device driver determines that the preset number of requests 304 for the plurality of data structures (i.e., first data structure 301, second data structure 302) is seven stored entries. The received first request 303 is stored, by the processing circuitry 103 in the first data structure at time t₂.

At time t₂, data of received first request 303 is stored in the first data structure 301 as one of the stored data entries of the second data structure 302 is accessed and removed to be used for processing. In addition, a second request 305 is received by the storage device driver 101 at time t₂. In some embodiments, the stored first request data 306 may include the first request data or an address pointing to the first request data stored in memory (e.g., memory 106). Once the first request data 306 is stored in the first data structure 301, the data structure depth of the first data structure 301 is eight stored data entries, while the data structure depth of the second data structure 302 is two stored data entries. In some embodiments the storage device driver 101 determines that the data structure depth of the first data structure 301 exceeds the preset number of requests 304. Therefore, the storage device driver 101 determines a second data structure based on the block size of the second request 305 and the memory available in the determined second data structure 302. In some embodiments, the storage device driver 101 determines whether the data structure depth of the second data structure 302 exceeds the preset number of requests 304. In the examples shown in FIG. 3, the storage device driver 101 determines to dynamically store the second request 305 in the second data structure 302.

At time t₃, the storage device driver 101 stores the second request 305 into the second data structure 302. In some embodiments, the stored second request data 307 may include the second request data or an address pointing to the second request data stored in memory (e.g., memory 106).

In some embodiments, the storage device driver 101 may determine a preset data structure memory instead of a preset number of requests and compare the stored memory of each data structure to the preset data structure memory to determine if a received request is to be dynamically stored to a second data structure.

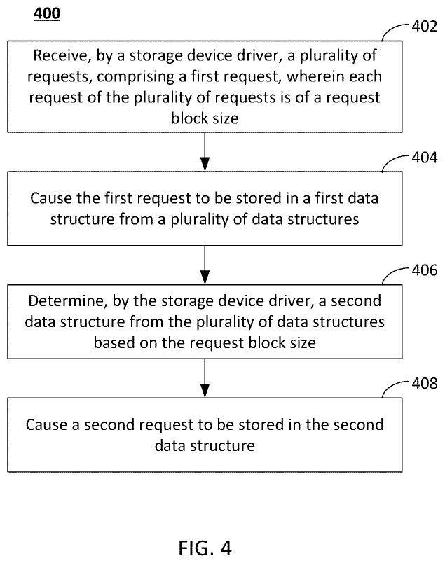

FIG. 4 shows a flowchart illustrating a process 400 for dynamically storing a second request into a second data structure, based on the request block size of the second request, in accordance with some embodiments of the present disclosure. In some embodiments, the referenced storage device driver, first request, and plurality of data structures may be implemented as storage device driver 101, request 105, and plurality of data structures 104, respectively. In some embodiments, the process 400 can be modified by, for example, having steps rearranged, changed, added, and/or removed.

At step 402, the storage device driver receives a first request with a request block size. The request block size is the largest possible memory size of the received first request, and therefore the largest amount of data memory that can be accessed by a single request. In some embodiments of the present disclosure, storage device driver receives a first request from a source. In some embodiments, the first request source may be located externally of the storage device. In other embodiments, the first request may originate from within the storage device. In some embodiments, the storage device driver receives requests from both internal and external sources of the storage device. After the receipt of the first request, the storage device driver then causes the first request to be stored in a first data structure, at step 404.

At step 404, the storage device driver causes the first request to be stored in a first data structure of a plurality of data structures. The storage device driver may determine a first data structure in which to store the first request. In some embodiments, the determined first data structure may be the data structure of the plurality of data structures with the smallest data structure depth. In some embodiments, the first data structure may be randomly determined by the storage device driver. According to the present disclosure, the first data structure may be any given data structure of the plurality of data structures in which the given data structure has more available memory capacity than the request block size. Once the first request is stored in a first data structure from the plurality of data structures, the storage device driver determines a second data structure from the plurality of data structures based on the request block size, at 406.

At step 406, the storage device driver determines a second data structure from the plurality of data structures based on the request block size. In some embodiments, the storage device driver determines the second data structure from the plurality of data structures based on the request block size and the data structure depth of each data structure in the plurality of data structures. In some embodiments, the device storage driver may use a preset number of requests or a preset data structure memory as a threshold for when to dynamically store a second received request to a second data structure. For example, if the data structure depth of the first data structure exceeds the preset number of requests, the storage device driver may determine a second data structure in which to store the second request. In some embodiments, the storage device driver determines a second data structure wherein the data structure depth of the second data structure does not exceed the preset number of requests and has more available memory capacity remaining than the request block size. In some embodiments, the second request may not be stored into a second data structure if each data structure of the plurality of data structures does not have enough available memory capacity remaining to store the second request or has a data structure depth that is greater than the data structure depth of the first data structure. Once the storage device driver determines a second data structure, the storage device driver causes the second request to be stored in the second data structure, at step 408.

At step 408, the second request is stored in the second data structure. In some embodiments, the storage device driver copies the data associated with the second request from the first data structure to the second data structure. In some embodiments, the storage device driver stores an address that points to the second request in memory. In some embodiments, wherein the plurality of data structures is one of a plurality of queues or plurality of buffers, the storage device driver appends the second request to the tail of the queue or buffer, which, in such embodiments, represents the second data structure. In other embodiments, wherein the plurality of data structures is a plurality of stacks, the storage device driver stores the second request by pushing the request onto the top of the stack, which represents the second data structure.

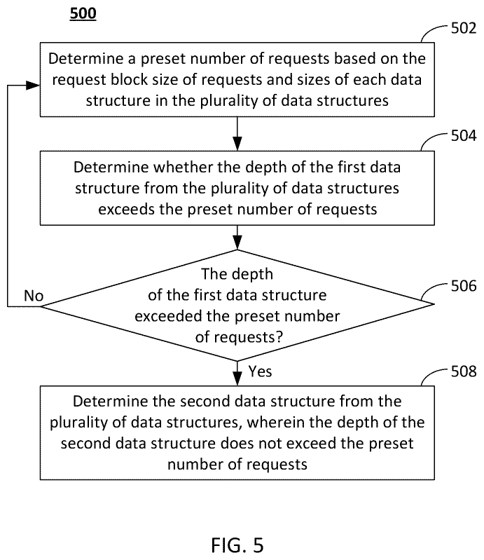

FIG. 5 shows a flowchart illustrating a process for determining to store a request in a second data structure, based on a preset number of requests and a depth of the first data structure, in accordance with some embodiments of the present disclosure. In some embodiments, the referenced storage device driver, request, and plurality of data structures may be implemented as storage device driver 101, request 105, and plurality of data structures 104, respectively. In some embodiments, the process 500 can be modified by, for example, having steps rearranged, changed, added, and/or removed.

At step 502, the storage device driver determines a preset number of requests based on the request block size of requests and sizes of each data structure in the plurality of data structures. In some embodiments, the preset number of requests may be determined, by the storage device driver, based on the rate of which the storage device driver receives requests. For example, assuming a controlled request block size and uniform size in each data structure in the plurality of data structures, a high rate of received requests may cause the storage device driver to determine a lower preset number of requests when compared to a low rate of received requests. In such an example of a high rate of received requests, the storage device driver may determine a smaller preset number of requests in order to ensure that the storage device driver has avoids a quick buildup of requests stored within a given data structure. In some embodiments, the determined preset number of requests is the same value for each data structure of the plurality of data structure, when the size of each data structure is the same for every data structure in the plurality of data structures. Once the preset number of requests is determined, the storage device driver uses the preset number of requests as a threshold value, at step 504.

At step 504, the storage device driver determines whether the depth of the first data structure from the plurality of data structures exceeds the preset number of requests. In some embodiments, the storage device driver compares the data structure depth of the first data structure to the determined preset number of requests. The storage device driver then determines the next step of process 500 based on whether the data structure depth of the first data structure exceeds the preset number of requests, at step 506.

At step 506, the storage device driver determines the next step of process 500 based on whether the depth of the first data structure exceeds the preset number of requests. If the data structure depth of the first data structure exceeds the preset number of requests, the storage device driver is to determine a second data structure from the plurality of data structures, wherein the data structure depth of the second data structure does not exceed the preset number of requests, at step 508. If the data structure depth of the first data structure does not exceed the preset number of requests, the storage device driver may determine that further received requests are to be stored in the first data structure. However, in some embodiments, the storage device driver may determine a new preset number of requests, at 502.

At step 508, the storage device driver determines a second data structure from the plurality of data structures, wherein the depth of the second data structure does not exceed the preset number of requests. In some embodiments, the storage device driver may compare the data structure depth of the second data structure to the preset number of requests. In addition, in some embodiments, the second data structure is to have more available memory remaining than the request block size in order to ensure a request may be stored in the determined second data structure.

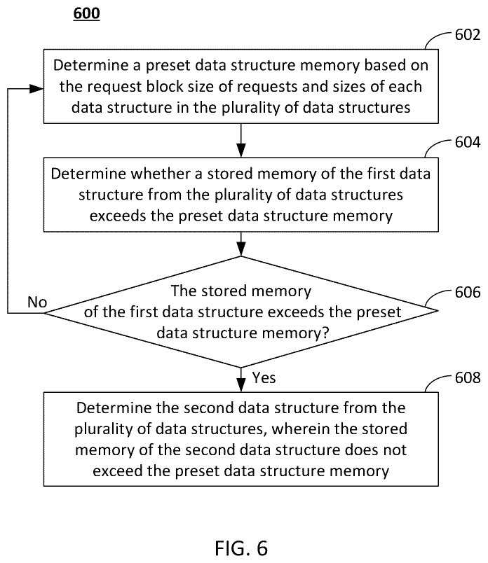

FIG. 6 shows a flowchart illustrating a process for determining to store a request in a second data structure, based on a preset data structure memory and a stored memory of the first data structure, in accordance with some embodiments of the present disclosure. In some embodiments, the referenced storage device driver, request, and plurality of data structures may be implemented as storage device driver 101, request 105, and plurality of data structures 104, respectively. In some embodiments, the process 600 can be modified by, for example, having steps rearranged, changed, added, and/or removed

At step 602, the storage device driver determines a preset data structure memory based on the request block size of requests and sizes of each data structure in the plurality of data structures. In some embodiments, the preset data structure memory may be determined, by the storage device driver, based on the rate of which the storage device driver receives requests. For example, assuming a controlled request block size and uniform size in each data structure in the plurality of data structures, a high rate of received requests may cause the storage device driver to determine a lower preset data structure memory when compared to a low rate of received requests. In such an example of a high rate of received request, the storage device driver may determine a smaller preset data structure memory in order to ensure that the storage device driver has avoids a quick buildup of requests stored within a given data structure. In some embodiments, the determined preset data structure memory is the same value for each data structure of the plurality of data structure, when the size of each data structure is the same for every data structure in the plurality of data structures. Once the preset data structure memory is determined, the storage device driver uses the preset data structure memory as a threshold value, at step 604.

At step 604, the storage device driver determines whether the stored memory of the first data structure from the plurality of data structures exceeds the preset data structure memory. In some embodiments, the stored memory of a data structure may be represented as the percent memory of the data structure currently storing requests. In some embodiments, the storage device driver compares the stored memory of the first data structure to the determined preset data structure memory. The storage device driver then determines the next step of process 500 based on whether the stored memory of the first data structure exceeds the preset data structure memory, at step 606.

At step 606, the storage device driver determines the next step of process 600 based on whether the stored memory of the first data structure exceeds the preset data structure memory. If the stored memory of the first data structure exceeds the preset data structure memory, the storage device driver is to determine a second data structure from the plurality of data structures, wherein the stored memory of the second data structure does not exceed the preset data structure memory, at step 608. If the stored memory of the first data structure does not exceed the preset data structure memory, the storage device driver may determine that further received requests are to be stored in the first data structure. However, in some embodiments, the storage device driver may determine a new preset data structure memory, at 602.

At step 608, the storage device driver determines a second data structure from the plurality of data structures, wherein the stored memory of the second data structure does not exceed the preset data structure memory. In some embodiments, the storage device driver may compare the stored memory of the second data structure to the preset data structure memory. In addition, in some embodiments, the second data structure is to have more available memory remaining than the request block size in order to ensure a request may be stored in the determined second data structure.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A storage device driver, comprising:
a plurality of data structures to store requests; and
processing circuitry, to:
receive a plurality of requests, comprising a first request and a second request, wherein each request of the plurality of requests is of a request block size,
cause the first request to be stored in a first data structure from the plurality of data structures,
determine a second data structure from the plurality of data structures based on the request block size, and
cause the second request to be stored in the second data structure from the plurality of data structures.

2. The storage device driver of claim 1, wherein the plurality of data structures is one of a plurality of buffers, a plurality of queues, a plurality of stacks, and a plurality of heaps.

3. The storage device driver of claim 1, wherein the first data structure is a same type of data structure as the second data structure.

4. The storage device driver of claim 1, wherein the plurality of data structures is to store non-volatile memory express (NVMe) requests, wherein the storage device driver is executed onto a solid-state drive (SSD) storage device.

5. The storage device driver of claim 1, wherein the processing circuitry is further to:
determine a depth of the first data structure, wherein determining the second data structure is further based on the depth of the first data structure.

6. The storage device driver of claim 5, wherein the processing circuitry is further to:
determine whether the depth of the first data structure has exceeded a preset number of requests,
and wherein determining the second data structure is further based on a depth of the second data structure exceeding the preset number of requests.

7. The storage device driver of claim 6, wherein the processing circuitry is further to:
determine the preset number of requests based on the request block size of requests and sizes of each data structure in the plurality of data structures.

8. The storage device driver of claim 1, wherein to determine the second data structure, the processing circuitry is further to:
determine whether a stored memory of the data structure has exceeded a preset data structure memory; and
in response to the determination that the stored memory of the first data structure has exceeded the preset data structure memory:
determine the second data structure, wherein the stored memory of the second data structure has not exceeded the preset data structure memory.

9. The storage device driver of claim 8, wherein the processing circuitry is to:
determine the preset data structure memory based on the request block size of requests and sizes of each data structure in the plurality of data structures.

10. The storage device driver of claim 1, wherein the processing circuitry is to:
determine the second data structure further based on the depth of the second data structure.

11. The storage device driver of claim 10, wherein the processing circuitry is further to:
determine the request block size of the second request; and
determine the second data structure based on a data structure with a smallest depth among the plurality of data structures.

12. A method, comprising:
receiving, by a storage device driver, a plurality of requests, comprising a first request, wherein each request of the plurality of requests is of a request block size;
causing the first request to be stored in a first data structure from a plurality of data structures;
determining, by the storage device driver, a second data structure from the plurality of data structures based on the request block size; and
causing a second request to be stored in the second data structure.

13. The method of claim 12, wherein the plurality of data structures is one of a plurality of queues, a plurality of stacks, and a plurality of heaps.

14. The method of claim 12, wherein the first data structure is a same type of data structure as the second data structure.

15. The method of claim 12, wherein the plurality of data structures is to store non-volatile memory express (NVMe) requests, wherein the storage device driver is executed onto a solid-state drive (SSD) storage device.

16. The method of claim 12, further comprising:
determining a depth of the first data structure, wherein determining the second data structure is further based on the depth of the first data structure.

17. The method of claim 16, further comprising:
determining whether the depth of the first data structure has exceeded a preset number of requests;
and wherein determining the second data structure is further based on a depth of the second data structure exceeding the preset number of requests.

18. The method of claim 17, further comprising:
determining the preset number of requests based on the request block size of requests and sizes of each data structure in the plurality of data structures.

19. The method of claim 12, wherein determining the second data structure, further comprising:
determining whether a stored memory of the first data structure has exceeded a preset data structure memory; and
in response to determining that the stored memory of the first data structure has exceeded the preset data structure memory:
determining the second data structure, wherein the stored memory of the second data structure has not exceeded the preset data structure memory.

20. The method of claim 19, further comprising:
determining the preset data structure memory based on the request block size of requests and data structure memory of each data structure in the plurality of data structures.

21. The method of claim 12, further comprising:
determining the second data structure further based on the depth of the second data structure.

22. The method of claim 21, further comprising:
determining the request block size of the second request; and
determining the second data structure based on a data structure with a smallest depth among the plurality of data structures.

23. A system, comprising:
storage circuitry, comprising:
a plurality of data structures to store requests; and
processing circuitry, to:
receive a plurality of requests, comprising a first request, wherein each request of the plurality of requests is of a request block size,
cause the first request to be stored in a first data structure from the plurality of data structures,
determine a second data structure from the plurality of data structures based on the request block size, and
cause a second request to be stored in the second data structure.

24. The system of claim 23, wherein the first data structure is a same type of data structure as the second data structure.

25. The system of claim 23, wherein the plurality of data structures is to store non-volatile memory express (NVMe) requests, wherein the storage circuitry is located on a solid-state drive (SSD) storage device.

26. The system of claim 23, wherein the processing circuitry is further to:
determine a depth of the first data structure, wherein determining the second data structure is further based on the depth of the first data structure.

27. The system of claim 26, wherein the processing circuitry is further to:
determine whether the depth of the first data structure has exceeded a preset number of requests,
and wherein determining the second data structure is further based on a depth of the second data structure exceeding the preset number of requests.
